(19) United States
(12) Patent Application Publication
(10) Pub. No.: US 2022/0255780 A1
(43) Pub. Date: Aug. 11, 2022

(54) Method for generating a signal comprising a temporal succession of chirps over time, method for estimating vehicle symbols using such a signal, computer program products and corresponding devices

(71) Applicants: UNIVERSITE DE BORDEAUX, BORDEAUX (FR); INSTITUT POLYTECHNIQUE DE BORDEAUX, TALENCE (FR); CENTRE NATIONAL DE LA RECHERCHE SCIENTIFIQUE, PARIS Cedex 16 (FR)

(72) Inventor: Guillaume Ferre, GRADIGNAN (FR)

(21) Appl. No.: 17/622,727

(22) PCT Filed: Jun. 22, 2020
(86) PCT No.: PCT/EP2020/067276

§ 371 Date: Dec. 24, 2021

(30) Foreign Application Priority Data
Jun. 25, 2019 (FR) FR1906861

(51) Int. Cl. H04L 27/10; H04B 1/69

(52) U.S. Cl. CPC H04L 27/103; H04B 2001/6912; H04B 1/69

(57) ABSTRACT

A method for generating a signal including a temporal succession of modulated chirps. The modulation corresponds to a circular permutation of the variation pattern of the instantaneous frequency of a base chirp over the symbol time Ts, obtained by a time shift of s times an elementary time period Te, such that M*Tc=Ts. Such a method includes, to generate a given chirp in the temporal succession of chirps, differential encoding between a modulation symbol associated with a chirp preceding the given chirp in the temporal succession of chirps, on the one hand, and a given information symbol of the constellation of M symbols, on the other hand, the differential encoding delivering a given modulation symbol; and modulating the base chirp on the basis of the given modulation symbol generating the given chirp.

### FIELD OF THE INVENTION

The field of the invention is that of data transmission via the use of what is known as a “chirp” waveform.

The invention relates more particularly to a method for generating and processing such a waveform, which method exhibits improved performance in comparison with existing techniques, with comparable implementation complexity.

Such a waveform is used to transmit data via communication links of different types, for example acoustic, radiofrequency, etc. For example, LoRa® technology, dedicated to the low-power transmission by objects connected via a radiofrequency link, uses such a waveform. The invention is thus applicable in particular, but not exclusively, in all areas of personal and professional life in which connected objects are present. These are for example the fields of health, sport, domestic applications (security, household appliances, etc.), object tracking, etc.

### PRIOR ART AND ITS DRAWBACKS

In the remainder of this document, an emphasis is placed more particularly on describing an existing problem in the field of connected objects in which LoRa® technology is used and with which the inventor of the present patent application was confronted. Of course, the invention is not limited to this particular field of application, but is of interest for the generation and processing of any communication signal based on the use of what is known as a “chirp” waveform and of coding of symbols to be transmitted via a circular permutation of the variation pattern of the instantaneous frequency of a base chirp, as detailed in the remainder of this application.

Presented as the “third revolution of the Internet”, connected objects are currently establishing themselves in all areas of daily life and business. Most of these objects are intended to produce data through their integrated sensors in order to provide value-added services for their owner.

Due to the applications that are targeted, these connected objects are mostly roaming. In particular, they have to be able to transmit the data that are produced, regularly or on demand, to a remote user.

To this end, cellular mobile radio (2G/3G/4G, etc.) long-range radio transmission has been one technology of choice. Specifically, this technology has made it possible to benefit from good network coverage in most countries.

However, the roaming aspect of these objects is often accompanied by a need for energy autonomy. However, even based on one of the most energy-efficient cellular mobile radio technologies, modern connected objects continue to exhibit consumption that is prohibitive to allowing large-scale deployment at a reasonable cost.

Faced with the problem of the consumption of the radio link for such roaming applications, new low-power and low-speed radio technologies dedicated specifically to “Internet of Things” networks, that is to say radio technologies for what are known as LPWAN (for “Low-Power Wide-Area Networks”) networks, are being developed.

In practice, a distinction may be drawn between two kinds of technology:
on the one hand, there are proprietary technologies such as for example the technology from the company Sigfox®, or LoRa® technology, or else the technology from the company Qowisio®. These non-standardized technologies are all based on the use of the “Industrial, Scientific and Medical” frequency band, known as ISM, and on the regulations associated with use thereof. The benefit of these technologies is that they are already available and allow the rapid deployment of networks on the basis of limited investments. They also make it possible to develop connected objects that are highly energy-efficient and inexpensive;
on the other hand, there are multiple technologies promoted by standardization bodies. By way of example, mention may be made of three technologies currently being standardized by the 3GPP (for “3rd Generation Partnership Project”): NB-IoT (for “Narrow Band-Internet of Things”), LTE MTC (for “Long Term Evolution-Machine Type Communication”) and EC-GSM-IoT (for “Extended Coverage-GSM-Internet of Things”). Such solutions are based on the use of licensed frequency bands.

Some telecommunications operators have already taken an interest in LoRa® technology to deploy their network dedicated to connected objects. For example, patent EP 2 449 690 B1 describes an information transmission technique on which LoRa® technology is based.

However, the initial feedback reveals unsatisfactory user experience linked to limited performance of the radio link in real conditions. In particular, the modulation that is used appears to be sensitive to both the time and the frequency synchronization of the receiver. Likewise, with radio resources being accessed by contention in a network of this type, intra-system collisions between transmissions by various objects connected to a given base station are inevitable. Now, it appears that it is difficult to manage such collisions with the modulation that is used. Moreover, the use of the ISM frequency band amplifies this phenomenon via potential interference with other radiofrequency devices using other radio protocols in the same frequency band (inter-system collisions).

There is thus a need to improve the performance, in real conditions, of a communication system using a modulation based on the circular permutation of a base chirp to transmit constellation symbols, such as for example in LoRa® technology. More particularly, there is a need to improve the robustness of the communication link in the presence of time and/or frequency synchronization errors. There is also a need to improve the robustness of the communication link in the presence of collisions between data frames (intra or inter-system collisions).

### DISCLOSURE OF THE INVENTION

In one embodiment of the invention, what is proposed is a method for generating a signal comprising a temporal succession of chirps from among M chirps, an s-th chirp from among said M chirps being associated with a modulation symbol of rank s of a constellation of M symbols, s being an integer from 0 to M−1. The s-th chirp results from a modulation of a base chirp, an instantaneous frequency of which varies between a first instantaneous frequency and a second instantaneous frequency during a symbol time Ts. The modulation corresponds, for the modulation symbol of rank s, to a circular permutation of the variation pattern of said instantaneous frequency over said symbol time Ts, obtained through a time shift of s times an elementary time period Tc, such that M*Tc=Ts. Such a generation method comprises, to generate a given chirp in the temporal succession of chirps:
differential encoding between a modulation symbol associated with a chirp preceding said given chirp in said temporal succession of chirps, on the one hand, and a given information symbol of said constellation of M symbols, on the other hand, said differential encoding delivering a given modulation symbol; and
modulation of the base chirp on the basis of the given modulation symbol generating the given chirp.

The invention thus proposes a novel and inventive solution for improving the performance, in real conditions, of a communication system using modulation based on the circular permutation of the variation pattern of the instantaneous frequency of a base chirp to transmit constellation symbols. More particularly, the differential encoding of the information symbols before the actual modulation of the chirps makes it possible to strengthen the communication link with respect to time and/or frequency synchronization errors. Due to its more robust behavior in respect of time synchronization problems, the system is also more robust in the presence of collisions between data frames (intra- or inter-system collisions).

According to one embodiment, the differential encoding implements a modulo M addition between a first operand dependent on said modulation symbol associated with said chirp preceding said given chirp, on the one hand, and a second operand dependent on said given information symbol, on the other hand, delivering said given modulation symbol.

The implementation is thus simple and robust.

According to one embodiment, the differential encoding and the modulation are implemented iteratively for a succession of information symbols, delivering a series of chirps in said temporal succession of chirps.

According to one embodiment, in a first implementation of said differential encoding, a predetermined constellation symbol is used instead of said modulation symbol associated with said chirp preceding said given chirp.

In one embodiment of the invention, what is proposed is a method for estimating at least one information symbol of a constellation of M symbols, s being an integer from 0 to M−1, conveyed by a signal comprising a temporal succession of chirps from among M chirps, an s-th chirp from among said M chirps being associated with a modulation symbol of rank s of said constellation of M symbols. The s-th chirp results from a modulation of a base chirp, an instantaneous frequency of which varies between a first instantaneous frequency and a second instantaneous frequency during a symbol time Ts. The modulation corresponds, for the modulation symbol of rank s, to a circular permutation of the variation pattern of said instantaneous frequency over said symbol time Ts, obtained through a time shift of s times an elementary time period Tc, such that M*Tc=Ts. Such an estimation method comprises, for a portion of said signal representative of a given chirp in said temporal succession of chirps:
demodulation of said portion of said signal, delivering an estimate of a modulation symbol associated with said given chirp; and
differential decoding between the estimate of the modulation symbol associated with said given chirp, on the one hand, and an estimate of a modulation symbol obtained beforehand by implementing said demodulation applied to another portion of said signal representative of a chirp preceding said given chirp in said temporal succession of chirps, on the other hand, said differential decoding delivering a decoded symbol, an estimate of an information symbol conveyed by said signal being dependent on said decoded symbol.

The differential decoding of the modulation symbols (the modulation symbols resulting from differential encoding of the information symbols at transmission) thus makes it possible to improve the data estimation performance in the presence of time and/or frequency synchronization errors and in the presence of collisions between data frames (intra- or inter-system collisions).

According to one embodiment, the differential decoding implements a modulo M difference between a first operand dependent on the estimate of the modulation symbol associated with said given chirp, on the one hand, and a second operand dependent on the estimate of the modulation symbol obtained beforehand, on the other hand, delivering the estimate of the information symbol conveyed by the signal.

The implementation is thus simple and robust.

According to one embodiment, the demodulation and the differential decoding are implemented iteratively for a succession of portions of the signal that are representative of a series of chirps in said temporal succession of chirps, delivering a corresponding series of decoded symbols, a series of estimates of information symbols conveyed by said signal being dependent on said series of decoded symbols.

According to one embodiment, in a first implementation of the differential decoding, a predetermined constellation symbol is used instead of the estimate of the modulation symbol obtained beforehand.

According to one embodiment, the demodulation of the signal implements:
term-to-term multiplication between N samples representative of said given chirp in said temporal succession of chirps, on the one hand, and N samples representative of a reference chirp, on the other hand, said multiplication delivering N multiplied samples; and
a Fourier transform of said N multiplied samples, delivering N transformed samples, said estimate of said modulation symbol associated with said given chirp being dependent on an index of a sample of highest amplitude from among said N transformed samples.

According to one embodiment, the instantaneous frequency of the base chirp varies linearly between the first instantaneous frequency and the second instantaneous frequency during the symbol time Ts.

The described technique is thus applicable for example to the LoRa© system.

The invention also relates to a computer program comprising program code instructions for implementing a method as described above, according to any one of its various embodiments, when it is executed on a computer.

In one embodiment of the invention, what is proposed is a device for generating a signal comprising a temporal succession of chirps from among M chirps. Such a generation device comprises a reprogrammable computing machine or a dedicated computing machine configured so as to implement the steps of the generation method according to the invention (according to any one of the various abovementioned embodiments). The features and advantages of this device are thus the same as those of the corresponding steps of the generation method described above. They are therefore not described in any more detail.

In one embodiment of the invention, what is proposed is a device for estimating at least one information symbol of a constellation of M symbols, s being an integer from 0 to M−1, conveyed by a signal comprising a temporal succession of chirps from among M chirps. Such an estimation device comprises a reprogrammable computing machine or a dedicated computing machine configured so as to implement the steps of the estimation method according to the invention (according to any one of the various abovementioned embodiments). The features and advantages of this device are thus the same as those of the corresponding steps of the estimation method described above. They are therefore not described in any more detail.

### LIST OF FIGURES

Other aims, features and advantages of the invention will become more clearly apparent on reading the following description, given by way of simple illustrative and non-limiting example, with reference to the figures, in which:

FIG. 1a, FIG. 1b and FIG. 1c illustrate the modulation of a base chirp via a circular permutation of the variation pattern of its instantaneous frequency;

FIG. 2 shows the steps of a method for generating a signal comprising a temporal succession of modulated chirps according to one embodiment of the invention;

FIG. 3 shows one example of a structure of a device for implementing the steps of the generation method of FIG. 2 according to one embodiment of the invention;

FIG. 4 shows the steps of a method for estimating information symbols carried by a signal as generated by the method of FIG. 2 according to one embodiment of the invention;

FIG. 5 shows one example of a structure of a device for implementing the steps of the estimation method of FIG. 4 according to one embodiment of the invention;

FIG. 6 illustrates the performance in terms of BER (for “Bit Error Rate”) obtained for a LoRa® communication system and for a communications system implementing the method of FIG. 2 and the method of FIG. 4 for various receiver time synchronization error values.

### DETAILED DESCRIPTION OF EMBODIMENTS OF THE INVENTION

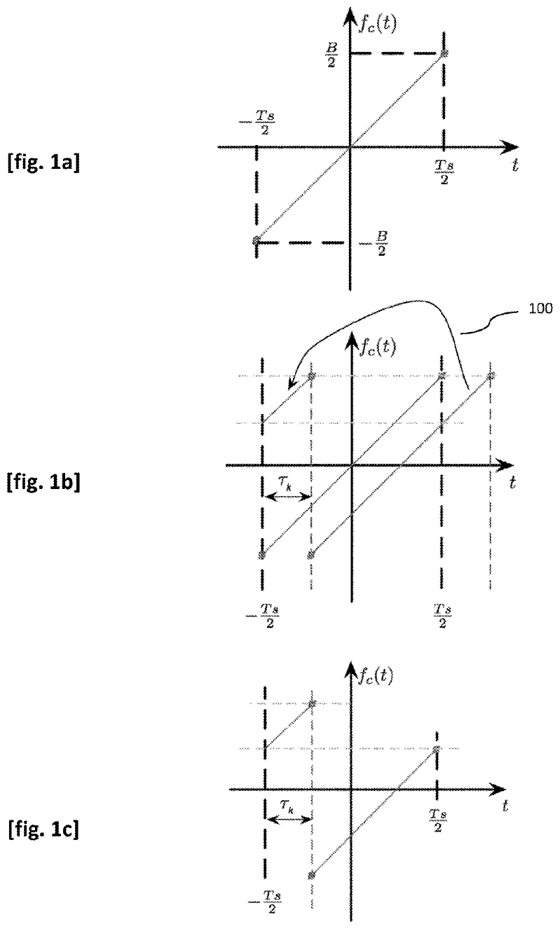

The general principle of the invention is based on the use of differential encoding of the information symbols to be transmitted in order to obtain modulation symbols that will effectively modulate the chirps used to generate the transmitted signal. Such differential encoding, in association with the corresponding differential decoding on the receiver side, makes it possible to improve the data estimation performance in the presence of time and/or frequency synchronization errors and in the presence of collisions between data frames (intra- or inter-system collisions), as detailed below. A presentation is now given, with reference to FIG. 1a, FIG. 1b and FIG. 1c, of the modulation of a base chirp via a circular permutation of the variation pattern of its instantaneous frequency.

More particularly, the chirps are intended to be transmitted on a carrier frequency. However, they are represented in baseband by their complex envelope. Such a complex envelope is expressed as follows in mathematical terms for

$$t ∈ [ - \frac{{T}_{s}}{2} , \frac{{T}_{s}}{2} {[}_{:}$$

$$c ( t ) = {e}^{j {θ}_{c} ( t )} where {θ}_{c} ( t ) = \pm 2 π \frac{B}{2 {T}_{s}} {t}^{2} \qquad [ Math 1 ]$$

where Ts is the symbol duration (also called signaling interval for example in the LoRa® standard), B is the bandwidth of the chirp signal, and is its instantaneous phase. The instantaneous frequency f_{c}(t) of the chirp signal may thus be written as follows:

$${f}_{c} ( t ) = \frac{1}{2 π} \frac{d {θ}_{c} ( t )}{dt} = \pm \frac{B}{{T}_{s}} t \qquad [ Math 2 ]$$

The instantaneous frequency f_{c}(t) is thus linked to the angular rotational speed in the complex plane of the vector whose coordinates are given by the in-phase and quadrature signals representing the modulating signal (that is to say the real and imaginary parts of the complex envelope in practice) intended to modulate the radiofrequency carrier so as to transpose the base chirp signal to a carrier frequency.

The instantaneous frequency f_{c}(t) illustrated in FIG. 1a is linear over time, that is to say varies linearly between a first instantaneous frequency, here −B/2, and a second instantaneous frequency, here +B/2, for the duration Ts of a symbol.

A chirp having a linear instantaneous frequency is for example used as base chirp (also called “raw” chirp) in the LoRa® standard. Such a base chirp is defined as the chirp used to obtain the other chirps that are used to transmit information following the modulation process by the modulation symbols.

Specifically, to distinguish between the various symbols of a constellation of M symbols, M orthogonal chirps have to be defined such that each symbol has a specific instantaneous phase trajectory. For example, the chirp associated with the k-th symbol Sₖ, where Sₖ∈{0, . . . , M−1} is obtained from the base chirp by performing a circular permutation of the variation pattern of the instantaneous frequency of the base chirp over the symbol time Ts. Such a circular permutation is obtained through a time shift

$${τ}_{k} = \frac{{S}_{k}}{B}$$

of k times an elementary time period Tc, such that M*Tc=Ts. Hence:

M=B×Tₛ [Math 3]

It may thus be seen that the base chirp in fact corresponds here to a chirp modulated by the symbol of rank 0 in the set of symbols as defined above. In other words, the base chirp corresponds to Sₖ for k=0.

The modulation process is illustrated more particularly in FIG. 1b and FIG. 1c, in which it is possible to see that the part of the base chirp outside the interval

$$[ - \frac{{T}_{s}}{2} , \frac{{T}_{s}}{2} ]$$

after time shifting is returned cyclically within the interval

$$[ - \frac{{T}_{s}}{2} , - \frac{{T}_{s}}{2} + {τ}_{k} ]$$

(arrow 100 in FIG. 1b). The modulated chirp linked to the transmission of the symbol k is thus broken down into two parts (FIG. 1c):
for

$$t ∈ [ - \frac{{T}_{s}}{2} , - \frac{{T}_{s}}{2} + {τ}_{k} ) ,$$

the slope of the instantaneous frequency f_{c}(t) of the base chirp is shifted forward in time by (Tₛ−τₖ); and
for

$$t ∈ [ - \frac{{T}_{s}}{2} + {τ}_{k} , \frac{{T}_{s}}{2} ] ,$$

the slope of the instantaneous frequency f_{c}(t) of the base chirp is shifted back in time by Tk.

The instantaneous frequency of the modulated chirp associated with the k-th symbol Sₖ may thereby be expressed as follows:

$${f}_{c}^{k} ( t ) = \frac{B}{{T}_{s}} ( t - {τ}_{k} ) + B for t ∈ [ - \frac{{T}_{s}}{2} , - \frac{{T}_{s}}{2} + {τ}_{k} ) ; and$$

$${f}_{c}^{k} ( t ) = \frac{B}{{T}_{s}} ( t - {τ}_{k} ) for t ∈ [ - \frac{{T}_{s}}{2} + {τ}_{k} , \frac{{T}_{s}}{2} ]$$

Finally, the complex envelope of the transmitted signal, corresponding to the temporal succession of chirps modulated by a series of constellation symbols Sₖ, may be written:

$$s ( t ) = {\sum }_{k ∈ ℤ} {e}^{j {θ}_{c}^{k} ( t - {kT}_{s} )} {[ \frac{{T}_{s} ( 2 k - 1 )}{2} , \frac{{T}_{s} ( 2 k + 1 )}{2} [}_{} ( t ) \qquad [ Math 4 ]$$

where [symbol] [a,b] is the indicator function of the interval [a, b], and f_{c}^{k}(t) is the instantaneous frequency of the chirp modulated by the symbol Sₖ transmitted at the instant k*Ts.

In other embodiments, the base chirp has an instantaneous frequency that remains linear, but with a negative slope.

Thus, generally for base chirps having a linear instantaneous frequency, the instantaneous frequency in question may be expressed as

$${f}_{c} ( t ) = \pm \frac{B}{{T}_{s}} t ,$$

where the signs “+” and “−” represent the positive or negative slopes of the instantaneous frequency f_{c}(t) of the corresponding chirp. In this case, reference is sometimes made to a positive chirp in the case of a positive slope or a negative chirp in the case of a negative slope.

In other embodiments that are not illustrated, a chirp having an instantaneous frequency that varies in any way between a first instantaneous frequency and a second instantaneous frequency during the symbol time Ts is chosen as base chirp. In these embodiments, the modulation process remains the same as described above, that is to say via a circular permutation of the variation pattern of the instantaneous frequency over the symbol time Ts. Only in these embodiments, consideration is given to any expression of the instantaneous frequency f_{c}(t).

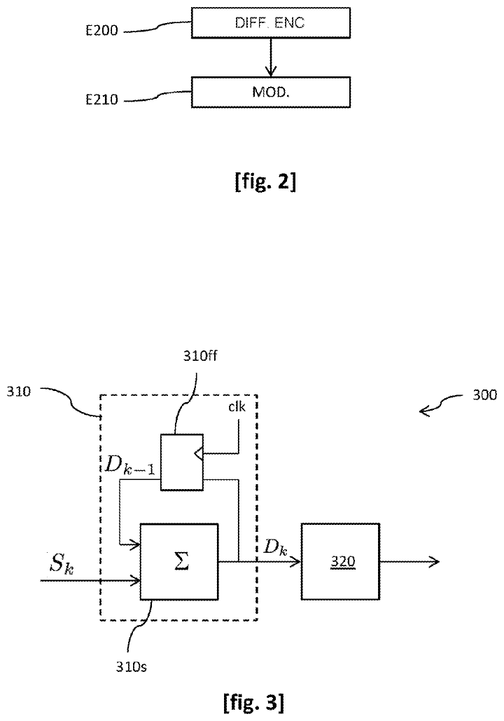

A presentation is now given, with reference to FIG. 2, of the steps of a method for generating a signal comprising a temporal succession of modulated chirps.

Compared to known techniques in which the information symbols Sₖ directly modulate the chirps forming the transmitted signal, differential encoding is applied thereto here in order to obtain the modulation symbols Dₖ. In this case, the information symbols Sₖ are the symbols conveying the information as such (in encoded form (entropy coding, error correcting coding, etc.) or non-encoded form). For example, the information symbols are obtained by mapping information bits onto the constellation symbol space. The modulation symbols k for their part are the symbols used for the actual modulation of the chirps.

More particularly, to generate a given chirp in the temporal succession of chirps, in a step E200, a given modulation symbol Dₖ is obtained through differential encoding between a modulation symbol Dₖ₋₁ associated with a chirp preceding the given chirp in the temporal succession of chirps, on the one hand, and a given information symbol Sₖ of the constellation of M symbols, on the other hand.

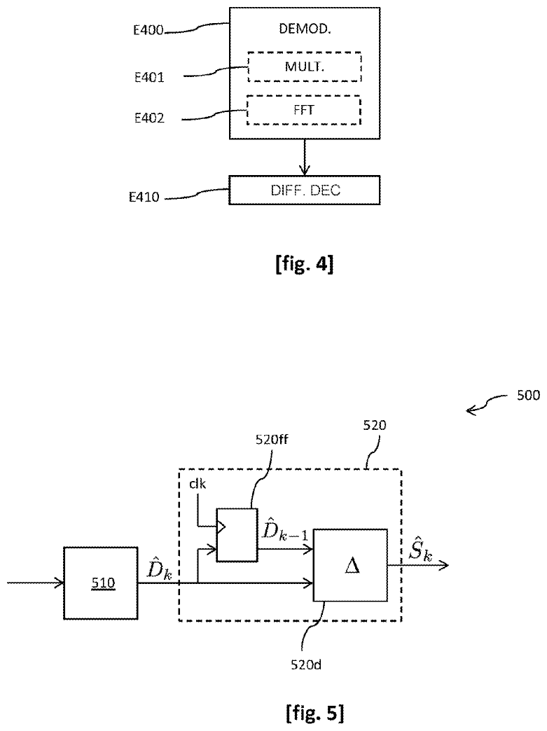

Next, in a step E210, a base chirp is modulated by the modulation symbol Dₖ in accordance with the modulation method described above with reference to FIG. 1a, FIG. 1b and FIG. 1c (circular permutation of the variation pattern of the instantaneous frequency of the base chirp over the symbol time Ts) in order to deliver a k-th modulated chirp in the temporal succession of chirps. The use of such differential encoding of the information symbols before actual modulation of the chirps makes it possible to strengthen the communication link with respect to time and/or frequency synchronization errors, as detailed below with reference to FIG. 4.

According to the embodiments under consideration, the instantaneous frequency of the base chirp varies linearly or non-linearly between a first instantaneous frequency and a second instantaneous frequency during the symbol time Ts.

In some embodiments, the differential encoding implements a modulo M addition between a first operand dependent on the modulation symbol Dₖ₋₁, on the one hand, and the second operand dependent on the given information symbol Sₖ, on the other hand. For example, the differential encoding implements the equation Dₖ=(S+Dₖ₋₁) mod M for k≥1. In the first implementation of the differential encoding (that is to say for k=0), a predetermined constellation symbol is used instead of the modulation symbol Dₖ₋₁.

In some embodiments, the given chirp and the chirp preceding the given chirp are not adjacent in the temporal succession of chirps. In other words, the given modulation symbol Dₖ is obtained through differential encoding between a modulation symbol Dₖ₋ₚ, where p is an integer greater than 1, and a given information symbol Sₖ of the constellation of M symbols, for example via a modulo M sum. In the present application, the terminology “chirp preceding the given chirp in the temporal succession of chirps” thus covers both the case of temporally adjacent chirps and the case of temporally non-adjacent chirps.

In some embodiments, additional differential encodings are also implemented. Each additional differential encoding is implemented between a modulation symbol Dₖ₋ₚ associated with a p-th chirp preceding the given chirp in the temporal succession of chirps, p being an integer greater than 1, on the one hand, and an information symbol S_{k-p′} of rank k−p′, p′ being an integer greater than 1 and other than p, in a series of information symbols of the constellation of M symbols, on the other hand. The additional differential encoding delivers a corresponding intermediate modulation symbol. The additional differential encodings implemented for K pairs (S_{k-p′}, Dₖ₋ₚ) deliver K corresponding intermediate symbols. The K intermediate symbols are summed together modulo M with the symbol obtained in the abovementioned case corresponding to a single differential encoding with p′=0, in order to deliver the modulation symbol Dₖ. In some embodiments, abovementioned steps E200 and E210 (regardless of their embodiment) are implemented iteratively for a succession of information symbols Sₖ in order to generate a temporal series of modulated chirps contained within the signal to be transmitted.

A presentation is now given, with reference to FIG. 3, of one example of a structure of a device 300 for implementing the steps of the generation method of FIG. 2 according to one embodiment of the invention.

More particularly, the device 300 comprises a differential encoder 310 for implementing step E200. The differential encoder 310 in this case comprises an modulo M adder 310s and a flip-flop 310ff (for example a D flip-flop) supplied with a clock signal clk at the symbol frequency 1/Ts. The flip-flop 310ff loops the output of the adder 310s back to one of the inputs of the adder 310s.

The device 300 also comprises a modulator 320 comprising computing means configured so as to implement modulation step E210 as described above (according to any one of the abovementioned embodiments).

This FIG. 3 illustrates only one particular way from among several possible ones of implementing the device 300 such that it performs certain steps of the method for generating the signal comprising a temporal succession of modulated chirps according to the invention (according to any one of the embodiments and/or variants described above with reference to FIG. 2). Specifically, these steps may be performed either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

If the device 300 is implemented with a reprogrammable computing machine, the corresponding program (that is to say the sequence of instructions) may be stored in a removable storage medium (such as for example a floppy disk, a CD-ROM or a DVD-ROM) or a non-removable one, this storage medium being able to be read in part or in full by a computer or a processor.

In some embodiments, the device 300 is embedded in a radiofrequency transmitter (for example a transmitter implementing the LoRa® protocol).

A presentation is now given, with reference to FIG. 4, of the steps of a method for estimating information symbols carried by a signal as generated by the method of FIG. 2.

More particularly, the estimation method implements the symmetrical steps of the generation method of FIG. 2. For example, in a step E400, a portion of the signal that is representative of a k-th chirp, called given chirp, in the received temporal succession of chirps is demodulated in order to deliver an estimate \hat{D}ₖ of a modulation symbol associated with the given chirp.

For example, in some embodiments, step E400 implements:
a step E401 of term-by-term multiplication between N samples representative of the given chirp, on the one hand, and N samples representative of a reference chirp (for example the complex conjugate of the base chirp used at transmission to generate the given chirp), on the other hand, the multiplication delivering N multiplied samples; and
a step E402 of Fourier-transforming the N multiplied samples, delivering N transformed samples.

In these embodiments, the estimate \hat{D}ₖ of the modulation symbol associated with the given chirp is dependent on the index of the sample of highest amplitude from among the N transformed samples. This is the demodulation principle disclosed in patent document EP 2 449 690 B1, but applied here to the case where the modulating symbols have been obtained at transmission from differential encoding of an information symbol.

In other embodiments, the estimate \hat{D}ₖ of the modulation symbol associated with the given chirp is obtained by implementing another demodulation method. For example, the variation pattern of the instantaneous frequency or phase of a modulated chirp is representative of the modulation symbol that it conveys. A phase-locked loop that converges over a duration less than the symbol time may thereby be implemented in order to extract the instantaneous frequency or phase of the given chirp and thus estimate the corresponding modulation symbol. As an alternative, what is known as a zero-crossing counting algorithm for estimating the periodicity of a signal may be implemented for the same purpose. Demodulation by using a correlator bank (demodulation in the sense of maximum likelihood) may also be implemented in some embodiments.

Returning to FIG. 4, in a step E410, an estimate Ŝₖ, of an information symbol (that is to say of a symbol more particularly conveying the information as described above) conveyed by the signal is obtained through differential decoding between the estimate \hat{D}ₖ of the modulation symbol associated with the given chirp, on the one hand, and an estimate Dₖ₋₁ of a modulation symbol obtained beforehand by implementing step E400 applied to another portion of the signal representative of a chirp preceding the given chirp in the temporal succession of chirps, on the other hand.

In some embodiments, the differential decoding implements a modulo M difference between a first operand dependent on the estimate \hat{D}ₖ of the modulation symbol associated with the given chirp, on the one hand, and a second operand dependent on the estimate \hat{D}ₖ₋₁ of the modulation symbol obtained beforehand, on the other hand. For example, the differential decoding implements the equation Ŝₖ=\hat{D}ₖ−\hat{D}ₖ₋₁ mod M. In the first implementation of the differential decoding (that is to say for k=0), a predetermined constellation symbol is used instead of the estimate \hat{D}ₖ₋₁.

In the abovementioned embodiments with reference to FIG. 2 in which the modulation symbol Dₖ is obtained through differential encoding between a modulation symbol Dₖ₋ₚ, where p is an integer greater than 1, and a given information symbol Sₖ of the constellation of M symbols, differential decoding between the estimate \hat{D}ₖ and an estimate of the modulation symbol conveyed by the p-th chirp preceding the given chirp in the temporal succession of chirps, that is to say \hat{D}ₖ₋ₚ, is implemented in order to deliver the estimate Sₖ of the information symbol, for example via a modulo M difference. In these embodiments, the rank k-p (that is to say in relation to the given chirp) of the chirp preceding the given chirp in the temporal succession of chirps is identical for the implementation of the differential decoding and of the differential encoding as described above with reference to FIG. 2.

Likewise, in the abovementioned embodiments with reference to FIG. 2 in which additional differential encodings are also implemented, corresponding additional differential decodings are also implemented between an estimate \hat{D}ₖ₋ₚ of the modulation symbol associated with a p-th chirp preceding the given chirp in the temporal succession of chirps, p being an integer greater than 1, on the one hand, and an estimate \hat{D}ₖ₋ₚ of the modulation symbol associated with a p′-th chirp preceding the given chirp in the temporal succession of chirps, p′ being an integer greater than 1 and other than p, on the other hand. The additional differential decoding in question delivers a corresponding decoded symbol. More precisely, the indices k−p and k−p′ of the components of each pair of estimates to which differential decoding is applied correspond to the indices of a corresponding pair (S_{k-p′}, Dₖ₋ₚ) for which differential encoding was implemented during the generation of the temporal succession of chirps. Such differential decoding implemented for K pairs (\hat{D}ₖ₋ₚ, \hat{D}ₖ₋ₚ) delivers K corresponding decoded symbols. The K decoded symbols in question are summed together modulo M with the decoded symbol obtained in the abovementioned case corresponding to a single differential decoding with p′=0, in order to deliver the estimate Ŝₖ of the information symbol.

In some embodiments, abovementioned steps E400 and E410 (regardless of their embodiment) are implemented iteratively for a succession of portions of the signal that are representative of a series of chirps in the temporal succession of chirps in order to extract a series of information symbols conveyed by the signal.

In some embodiments, the information bits are obtained from the information symbols by following a reverse mapping scheme of the constellation of symbols.

Regardless of the abovementioned embodiment under consideration, the differential decoding of the modulation symbols (modulation symbols resulting from differential encoding of the information symbols at transmission) makes it possible to improve the data estimation performance in the presence of time and/or frequency synchronization errors and in the presence of collisions between data frames (intra- or inter-system collisions).

This may be demonstrated by applying for example the processing operations in steps E400 and E410 according to the embodiment of FIG. 4 to a signal received in the presence or absence of a (time and/or frequency) synchronization error.

Specifically, in the case of ideal time and frequency synchronization of the receiver, the samples of the received signal, y(t), sampled with a sampling period Te, may be written:

y(nTe)=s(nTₑ)+w(nTe) [Math 5]

where w(nTe) represents complex noise that is assumed to be white, Gaussian and circular.

The transmitted symbols are detected here by multiplying each portion of duration Ts of the complex envelope of the received signal by the conjugated version of the base chirp used at the transmitter. If it is accepted that the propagation channel does not introduce any interference between chirps (or if a guard interval between chirps has been introduced at the transmitter), the demodulation of the p-th transmitted symbol

$$( {pT}_{s} - \frac{{T}_{s}}{2} \leq t < {pT}_{s} + \frac{{T}_{s}}{2} )$$

corresponds to the processing of N=Ts/Te samples expressed as:

rₚ(nTₑ)=y(nTₑ+pTₛ)e^{-jθ}^{ₑ}^{(nT}^{ₑ}⁾ [Math 6]

where

$$n ∈ 〚 - \frac{N}{2} , \frac{N}{2} - 1 〛 .$$

Thus, within this interval, all of the terms of the sum of the equation [Math 4] are zero, except for the term k=p. Thus:

y(nTₑ+pTₛ)=e^{θ}^{ₑ}^{^{y}}^{(nT}^{ₑ}⁾+w(nTₑ+pTₛ) [Math 7]

Moreover, substituting the equation [Math 7] into the equation [Math 6] gives:

rₚ(nTₑ)=xₚ(nTₑ)+wₚ(nTₑ) [Math 8]

where the payload signal is equal to:

xₚ(nTₑ)=(e^{jθ}^{_{c}}^{^{p}}^{nT}^{ₑ}⁾)e^{-jθ}^{_{c}}^{(nT}^{ₑ}⁾ [Math 9]

and where the term corresponding to noise is expressed as:

wₚ(nTₑ)=w(nTₑ+pTₛ)e^{-jθ}^{ₑ}^{)c} [Math 10]

Thus, by multiplying the two terms of the equation [Math 9], the arguments are expressed as:

$$( - 2 π \frac{{S}_{p}}{{T}_{s}} {nT}_{e} + 2 π {BnT}_{e} ) for n ∈ [ - \frac{N}{2} , - \frac{N}{2} + \frac{{S}_{p}}{{T}_{e} B} )$$

$$( - 2 π \frac{{S}_{p}}{{T}_{s}} {nT}_{e} ) for n ∈ [ - \frac{N}{2} + \frac{{S}_{p}}{{T}_{e} B} , \frac{N}{2} )$$

In addition, sampling the signal with a sampling period Te=1/B gives, using the equation [Math 3]:

$${r}_{p} ( {nT}_{e} ) = {e}^{- j 2 π \frac{{S}_{p}}{M}} + {w}_{p} ( {nT}_{e} ) \qquad [ Math 11 ]$$

It should be noted that this choice of sampling frequency leads to M=N. Specifically, rₚ(nTₑ) is the sum of a complex exponential having a normalized frequency equal to Sₚ/N, on the one hand, and of Gaussian noise, on the other hand. The optimum estimate of Sₚ, and therefore the detection of the associated symbol, may thus be performed by searching for the maximum of the periodogram of rₚ(nTₑ).

Based on the demodulation solution proposed in patent EP 2 449 690 B1, the discrete Fourier transform at a frequency k/N of the N samples of rₚ(nTₑ) denoted Rₚ[k] for k∈ [symbol] 0, N−1 [symbol] , is expressed as follows:

$${R}_{p} [ k ] = \frac{1}{\sqrt{N}} {\sum }_{n = - \frac{N}{2}}^{\frac{N}{2} - 1} {r}_{p} ( {nT}_{e} ) {e}^{- j 2 π \frac{nk}{N}} \qquad [ Math 12 ]$$

Using the periodicity of the discrete Fourier transform, Rₚ[k] may be expressed as follows:

Rₚ[k]=Rₚ[k−N]=\sqrt{N}δ(k+Sₚ−N)+Wₚ[k] [Math 13]

where Wₚ[k] is the discrete Fourier transform of the noise term wₚ(nTₑ). It thus seems that Wₚ[k] is white, Gaussian and with the same variance as wₚ(nTₑ). An estimate Ŝₚ of Sₚ is then given by:

$${\hat{S}}_{p} = N - {argmax}_{k ∈ 〚 0 , N - 1 〛} ( {\vert {R}_{p} [ k ] \vert}^{2} ) \qquad [ Math 14 ]$$

If the time and frequency synchronization of the receiver is not ideal, the signal received in baseband, y(t), is expressed as:

y(t)=s(t−δτ)e^{j2πδft}+w(t) [Math 15]

where δτ is the time synchronization error and is the frequency synchronization error.

The abovementioned demodulation and decoding steps will again be applied to the p-th chirp received. The time synchronization error means that the signal processed by the discrete Fourier transform at the receiver consists of a signal portion resulting from two consecutive transmitted symbols. To formalize this phenomenon, sₚ(t) will be defined as equal to:

$${s}_{p} ( t ) = {e}^{j {θ}_{c}^{p} ( t )} {[ - \frac{{T}_{s}}{2} , \frac{{T}_{s}}{2} [}_{} ( t ) \qquad [ Math 16 ]$$

If δτ<0, the samples of y(t) corresponding to the p-th symbol, that is to say yₚ(t+pTₛ) may be written for

$$t ∈ [ - \frac{{T}_{s}}{2} , \frac{{T}_{s}}{2} [$$

as:

(sₚ₋₁(t+Tₛ−δτ)+sₚ(t−δτ))e^{j2πδft}+w(t+pTₛ) [Math 17]

Likewise, if δτ>0, yₚ(t+pTₛ) is expressed for

$$t ∈ [ - \frac{{T}_{s}}{2} , \frac{{T}_{s}}{2} [$$

as:

(sₚ₊₁(t−Tₛ+δτ)+sₚ(t−δτ))e^{2πδft}+w+(t+pTₛ) [Math 18]

Consideration will be given for example to the case associated with the equation [Math 18], that is to say the case where δτ>0. By applying the abovementioned demodulation principle to the signal yₚ(t+pTₛ), yₚ(nTₑ+pTₛ) (which represents the sampling of yₚ(t+pTₛ) at instants that are multiples of Te=1/B, where n is the multiplicative factor such that

$$n ∈ 〚 - \frac{N}{2} , \frac{N}{2} - 1 〛 )$$

is first multiplied by the conjugated version of the base chirp used at the transmitter to give rₚ(nTₑ). Finally, a discrete Fourier transform is applied for symbol detection. After algebraic manipulation, this gives:

$$\begin{matrix}{s}_{p - 1} ( {nT}_{e} + {T}_{s} - δτ ) {e}^{- j {θ}_{c} ( {nT}_{e} )} = {e}^{- j 2 {πϕ}_{p - 1}} \times {e}^{- j 2 π n ( \frac{δ τ + {s}_{p - 1} {T}_{e}}{{T}_{s}} )} & [ Math 19 ] \\ and \text{:} & \\ {s}_{p} ( {nT}_{r} - δτ ) {e}^{- j 2 π {f}_{c} ( {nT}_{e} ) {nT}_{e}} = {e}^{- j 2 {πϕ}_{p}} \times {e}^{- j 2 π n ( \frac{δτ + {s}_{p} {T}_{s}}{{T}_{s}} )} & [ Math 20 ]\end{matrix}$$

where

$${ϕ}_{p - 1} = 2 π ( {T}_{s} - δ τ ) \frac{B}{T \text{?}} ( {T}_{s} - δ τ - {S}_{p - 1} {T}_{e} ) and \\ {ϕ}_{p} = 2 πδτ \frac{B}{T \text{?}} ( δτ + {S}_{p} {T}_{e} ) \\ \text{?} \text{indicates text missing or illegible when filed}$$

represent two constant arguments, which have no impact on the symbol estimate.

rₚ(nTₑ) thus consists of three terms:

1) A contribution to the (p−1)-th chirp transmitted during the time interval (0, └δτB┘):

$${υ}_{p - 1} ( {nT}_{e} ) = {e}^{- j 2 π {ϕ}_{p - 1}} {e}^{- j 2 π n ( \frac{δτ + {S}_{p - 1} {T}_{e}}{T \text{?}} + δ f {T}_{e} )} \\ \text{?} \text{indicates text missing or illegible when filed} \qquad [ Math 21 ]$$

2) A contribution to the p-th chirp transmitted during the time interval [└δτB┘, N−1]:

$${υ}_{p} ( {nT}_{e} ) = {e}^{- j 2 π {ϕ}_{p}} {e}^{- j 2 π n ( \frac{δτ + {S}_{p} {T}_{e}}{T \text{?}} + δ f {T}_{e} )} \\ \text{?} \text{indicates text missing or illegible when filed} \qquad [ Math 22 ]$$

3) A noise term corresponding to that given by the equation [Math 10].

It thus seems that rₚ(nTₑ) may be expressed as follows:

rₚ(nTₑ)=vₚ₋₁(nTₑ) [symbol] _{(0,└δτB┘)}(n)+vₚ(nTₑ) [symbol] _{[└ϵτB┘,N-1]}(n)+wₚ(nTₑ) [Math 23]

It may be noted that the equation [Math 23] may be reduced to the equation [Math 11] in the case of perfect time and frequency synchronization, that is to say when δτ=δf=0.

As demonstrated by the equation [Math 23], when the received signal is not perfectly synchronized, inter-symbol interference occurs. This results in a frequency shift of the maximum of the periodogram, leading to a biased estimated symbol. More precisely, the peak at the output of the discrete Fourier transform is no longer located at the frequency corresponding to the p-th symbol, and a secondary peak may possibly be present. However, δτ and δf remain the same for multiple consecutive symbols. They therefore lead to a systematic error that is removed when implementing the differential estimate as proposed in the present application.

More particularly, as described above with reference to FIG. 2, the symbols Dₖ modulating the chirps forming the transmitted signal are obtained through differential encoding, for example according to the following equation in the corresponding abovementioned embodiments:

Dₖ=(Sₖ+Dₖ₋₁)mod M for k≥1 [Math 24]

where Sₖ is a k-th information symbol belonging to the constellation of M symbols. Likewise, the information symbols are estimated at reception through differential decoding of the estimates of the modulation symbols. Denoting Ŝₖ as the estimate of the k-th information symbol and \hat{D}ₖ as the estimate of the k-th modulating symbol, the estimates Ŝₖ are obtained for example according to the equation in the corresponding abovementioned embodiments:

Ŝₖ=\hat{D}ₖ−\hat{D}ₖ₋₁ mod M. [Math 25]

On the basis of the equation [Math 25], it is observed that, if there is a bias in the estimate according to the equation [Math 14], this is removed by the proposed differential processing. Specifically, the processing proposed via the equation [Math 25] removes the terms

$$( \frac{{δ}_{τ}}{T \text{?}} + δ f {T}_{e} ) \\ \text{?} \text{indicates text missing or illegible when filed}$$

in the equations [Math 21] and [Math 22].

The proposed technique is thereby robust against time and frequency synchronization errors of the receiver. Moreover, in the event of a collision between frames (both in the case of an intra-system collision and in the case of an inter-system collision), a receiver might not be able to synchronize with the received signal due to the mixing of multiple signals. However, the robustness to time synchronization errors of a communication link implementing the described technique means that the performance in the event of a collision between frames is also improved.

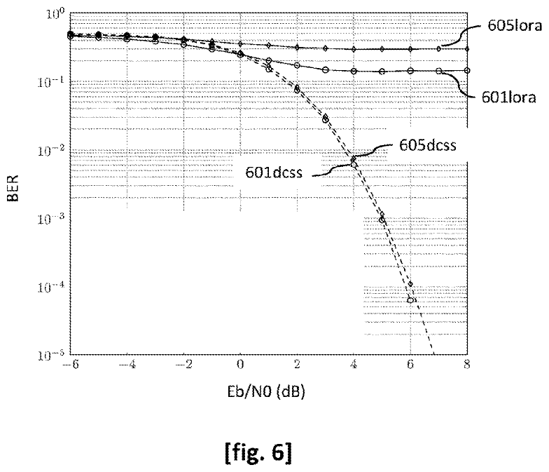

A presentation is now given, with reference to FIG. 5, of one example of a structure of a device 500 for implementing the steps of the estimation method of FIG. 4 according to one embodiment of the invention.

More particularly, the device 500 comprises a demodulator 510 comprising computing means configured so as to implement modulation step E400 (according to any one of the abovementioned embodiments).

The device 500 also comprises a differential decoder 520 for implementing step E410. The differential decoder 520 in this case comprises a modulo M subtractor 520d and a flip-flop 520ff (for example a D flip-flop), supplied with a clock signal clk at the symbol frequency 1/Ts. The flip-flop 520ff delays the estimates \hat{D}ₖ delivered by the demodulator 510 by one clock cycle.

This FIG. 5 illustrates only one particular way from among several possible ones of implementing the device 500 such that it performs certain steps of the method for estimating information symbols carried by a signal comprising a temporal succession of modulated chirps (according to any one of the embodiments and/or variants described above with reference to FIG. 4). Specifically, these steps may be performed either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

If the device 500 is implemented with a reprogrammable computing machine, the corresponding program (that is to say the sequence of instructions) may be stored in a removable storage medium (such as for example a floppy disk, a CD-ROM or a DVD-ROM) or a non-removable one, this storage medium being able to be read in part or in full by a computer or a processor.

In some embodiments, the device 500 is embedded in a radiofrequency transmitter (for example a receiver implementing the LoRa® protocol).

A presentation is now given, with reference to FIG. 6, of the performance obtained by simulation for a LoRa® communication system and for a communications system implementing the methods of FIG. 2 and of FIG. 4 for various receiver synchronization error values.

More particularly, the curves 601dcss and 605dcss correspond to the performance obtained on a communication link in the presence of additive white noise for a transceiver system implementing the methods of FIG. 2 and FIG. 4, respectively for a time synchronization error value equal to 1% of Ts (curve 601dcss) and to 5% of Ts (curve 605dcss).

Likewise, the curves 6011ora and 6051ora correspond to the performance obtained on a communication link in the presence of additive white noise for a transceiver system implementing the technique of patent EP 2 449 690 B1, respectively for the same time synchronization error values, that is to say 67 of 1% of Ts (curve 6011ora) and of 5% of Ts (curve 6051ora).

The technique described in the present application thus makes it possible to significantly improve the performance in terms of BER of the communications link in the presence of a synchronization error.

1. A generation method comprising:
generating a signal comprising a temporal succession of chirps from among M chirps, an s-th chirp from among said M chirps being associated with a modulation symbol of rank s of a constellation of M symbols, s being an integer from 0 to M−1,
said s-th chirp resulting from a modulation of a base chirp, an instantaneous frequency of which varies between a first instantaneous frequency and a second instantaneous frequency during a symbol time Ts,
said modulation corresponding, for said modulation symbol of rank s, to a circular permutation of the variation pattern of said instantaneous frequency over said symbol time Ts, obtained through a time shift of s times an elementary time period Tc, such that M*Tc=Ts,
wherein the generating comprises, to generate a given chirp in said temporal succession of chirps:
differential encoding between a modulation symbol associated with a chirp preceding said given chirp in said temporal succession of chirps, on the one hand, and a given information symbol of said constellation of M symbols, on the other hand, said differential encoding delivering a given modulation symbol; and
modulation of said base chirp on the basis of said given modulation symbol generating said given chirp;
said differential encoding and said modulation being implemented iteratively for a succession of information symbols, delivering a series of chirps in said temporal succession of chirps.

2. The generation method as claimed in claim 1, wherein said differential encoding implements a modulo M addition between a first operand dependent on said modulation symbol associated with said chirp preceding said given chirp, on the one hand, and a second operand dependent on said given information symbol, on the other hand, delivering said given modulation symbol.

3. An estimation method comprising:
estimating at least one information symbol of a constellation of M symbols, s being an integer from 0 to M−1, conveyed by a signal comprising a temporal succession of chirps from among M chirps, an s-th chirp from among said M chirps being associated with a modulation symbol of rank s of said constellation of M symbols,
said s-th chirp resulting from a modulation of a base chirp, an instantaneous frequency of which varies between a first instantaneous frequency and a second instantaneous frequency during a symbol time Ts,
said modulation corresponding, for said modulation symbol of rank s, to a circular permutation of the variation pattern of said instantaneous frequency over said symbol time Ts, obtained through a time shift of s times an elementary time period Tc, such that M*Tc=Ts,
wherein the estimating comprises, for a portion of said signal representative of a given chirp in said temporal succession of chirps:
demodulation of said portion of said signal, delivering an estimate of a modulation symbol associated with said given chirp; and
differential decoding between said estimate of said modulation symbol associated with said given chirp, on the one hand, and an estimate of a modulation symbol obtained beforehand by implementing said demodulation applied to another portion of said signal representative of a chirp preceding said given chirp in said temporal succession of chirps, on the other hand, said differential decoding delivering a decoded symbol, an estimate of an information symbol conveyed by said signal being dependent on said decoded symbol,
said demodulation and said differential decoding being implemented iteratively for a succession of portions of said signal that are representative of a series of chirps in said temporal succession of chirps, delivering a corresponding series of decoded symbols, a series of estimates of information symbols conveyed by said signal being dependent on said series of decoded symbols.

4. The estimation method according to claim 3 wherein demodulation of said portion of said signal, delivering an estimate of a modulation symbol associated with said given chirp comprises:
term-to-term multiplication between N samples representative of said given chirp in said temporal succession of chirps, on the one hand, and N samples representative of a reference chirp, on the other hand, said multiplication delivering N multiplied samples; and
a Fourier transform of said N multiplied samples, delivering N transformed samples,
said estimate of said modulation symbol associated with said given chirp being dependent on an index of a sample of highest amplitude from among said N transformed samples.

5. The estimation method as claimed in claim 3, wherein said differential decoding implements a modulo M difference between a first operand dependent on said estimate of said modulation symbol associated with said given chirp, on the one hand, and a second operand dependent on said estimate of said modulation symbol obtained beforehand, on the other hand, delivering said estimate of said information symbol conveyed by the signal.

6. The estimation method as claimed in claim 4, wherein said demodulation and said differential decoding are implemented iteratively for a succession of portions of said signal that are representative of a series of chirps in said temporal succession of chirps, delivering a corresponding series of decoded symbols, a series of estimates of information symbols conveyed by said signal being dependent on said series of decoded symbols.

7. The estimation method as claimed in claim 3, wherein said demodulation of said signal implements:
term-to-term multiplication between N samples representative of said given chirp in said temporal succession of chirps, on the one hand, and N samples representative of a reference chirp, on the other hand, said multiplication delivering N multiplied samples; and
a Fourier transform of said N multiplied samples, delivering N transformed samples,
said estimate of said modulation symbol associated with said given chirp being dependent on an index of a sample of highest amplitude from among said N transformed samples.

8. (canceled)

9. A device comprising:
a dedicated or reprogrammable computing machine configured so as to perform to generate a signal comprising a temporal succession of chirps from among M chirps, an s-th chirp from among said M chirps being associated with a modulation symbol of rank s of a constellation of M symbols, s being an integer from 0 to M−1,
said s-th chirp resulting from a modulation of a base chirp, an instantaneous frequency of which varies between a first instantaneous frequency and a second instantaneous frequency during a symbol time Ts,
said modulation corresponding, for said modulation symbol of rank s, to a circular permutation of the variation pattern of said instantaneous frequency over said symbol time Ts, obtained through a time shift of s times an elementary time period Tc, such that M*Tc=Ts,
wherein the generating comprises, to generate a given chirp in said temporal succession of chirps:
differential encoding between a modulation symbol associated with a chirp preceding said given chirp in said temporal succession of chirps, on the one hand, and a given information symbol of said constellation of M symbols, on the other hand, said differential encoding delivering a given modulation symbol; and
modulation of said base chirp on the basis of said given modulation symbol generating said given chirp;
said differential encoding and said modulation being implemented iteratively for a succession of information symbols, delivering a series of chirps in said temporal succession of chirps.

10. The device according to claim 9, comprising:
a dedicated or reprogrammable computing machine configured so as to perform to estimate at least one information symbol of a constellation of M symbols, conveyed by a received signal comprising a temporal succession of chirps from among M chirps, an s-th chirp from among said M chirps being associated with a modulation symbol of rank s of said constellation of M symbols of the received signal,
said s-th chirp of the received signal resulting from a modulation of a base chirp, an instantaneous frequency of which varies between the first instantaneous frequency and the second instantaneous frequency during the symbol time Ts,
said modulation corresponding, for said modulation symbol of rank s, to the circular permutation of the variation pattern of said instantaneous frequency over said symbol time Ts, obtained through the time shift of s times an elementary time period Tc, such that M*Tc=Ts,
wherein the estimating comprises, for a portion of said received signal representative of a given chirp in said temporal succession of chirps:
demodulation of said portion of said received signal, delivering an estimate of a modulation symbol associated with said given chirp comprising:
term-to-term multiplication between N samples representative of said given chirp in said temporal succession of chirps, on the one hand, and N samples representative of a reference chirp, on the other hand, said multiplication delivering N multiplied samples; and
a Fourier transform of said N multiplied samples, delivering N transformed samples,
said estimate of said modulation symbol associated with said given chirp being dependent on an index of a sample of highest amplitude from among said N transformed samples; and
differential decoding between said estimate of said modulation symbol associated with said given chirp, on the one hand, and an estimate of a modulation symbol obtained beforehand by implementing said demodulation applied to another portion of said received signal representative of a chirp preceding said given chirp in said temporal succession of chirps, on the other hand, said differential decoding delivering a decoded symbol, an estimate of an information symbol conveyed by said received signal being dependent on said decoded symbol.

11. The estimation method as claimed in claim 4, wherein said differential decoding implements a modulo M difference between a first operand dependent on said estimate of said modulation symbol associated with said given chirp, on the one hand, and a second operand dependent on said estimate of said modulation symbol obtained beforehand, on the other hand, delivering said estimate of said information symbol conveyed by the signal.

12. The estimation method as claimed in claim 5, wherein said demodulation and said differential decoding are implemented iteratively for a succession of portions of said signal that are representative of a series of chirps in said temporal succession of chirps, delivering a corresponding series of decoded symbols, a series of estimates of information symbols conveyed by said signal being dependent on said series of decoded symbols.

13. The estimation method as claimed in claim 5, wherein said demodulation of said signal implements:
term-to-term multiplication between N samples representative of said given chirp in said temporal succession of chirps, on the one hand, and N samples representative of a reference chirp, on the other hand, said multiplication delivering N multiplied samples; and
a Fourier transform of said N multiplied samples, delivering N transformed samples,
said estimate of said modulation symbol associated with said given chirp being dependent on an index of a sample of highest amplitude from among said N transformed samples.
